(19) United States
(12) Patent Application Publication
(10) Pub. No.: US 2017/0345263 A1
(43) Pub. Date: Nov. 30, 2017

(54) CHECKOUT SYSTEM

(71) Applicant: TOSHIBA TEC KABUSHIKI KAISHA, Tokyo (JP)

(72) Inventor: Tsuyoshi Gotanda, Ota Tokyo (JP)

(21) Appl. No.: 15/602,182

(22) Filed: May 23, 2017

(30) Foreign Application Priority Data
May 24, 2016 (JP) 2016-103376

(51) Int. Cl. G07G 1/00; B62B 5/00; G06Q 20/20; G07G 5/00

(52) U.S. Cl. CPC G07G 1/0072; G07G 5/00; B62B 5/0096; G06Q 20/209

(57) ABSTRACT

A checkout system comprises a commodity data registration apparatus for executing a commodity sales registration processing; a table for temporarily placing a registered basket including a registered commodity after the commodity sales registration processing; a first checkout apparatus arranged next to the table and configured to execute a checkout processing based on data relating to the commodity sales registration processing selectively sent from the commodity data registration apparatus; a second checkout apparatus arranged next to the first checkout apparatus and configured to execute a checkout processing based on data relating to the commodity sales registration processing selectively sent from the commodity data registration apparatus; and a recognition module for recognizing that the registered basket is positioned for the first checkout apparatus or the second checkout apparatus which is a transmission destination of the data.

### CROSS-REFERENCE TO RELATED APPLICATIONS

This application is based upon and claims the benefit of priority from Japanese Patent Application No. 2016-103376, filed May 24, 2016, the entire contents of which are incorporated herein by reference.

### FIELD

Embodiments described herein relate generally to a checkout system and checkout method.

### BACKGROUND

In a distribution retail industry including a food supermarket, a semi-self-type checkout system is introduced. The semi-self-type checkout system is a system for an operator such as a checker to execute commodity sales registration processing and for a customer to execute checkout processing. With such a constitution, the semi-self-type checkout system improves checkout speed.

Generally, in many cases, the semi-self-type checkout system has a device constitution in which two checkout apparatuses that execute the checkout processing are arranged for one commodity data registration apparatus that executes the commodity sales registration processing, or three checkout apparatuses for two commodity data registration apparatuses. In this way, the semi-self-type checkout system can execute a commodity data registration job and a checkout job in parallel by enabling a larger number of the checkout apparatuses than the number of the commodity data registration apparatuses.

Incidentally, in many cases, in the semi-self-type checkout system, a shopping basket (registered basket) containing a commodity to which the commodity sales registration processing is already executed in the commodity data registration apparatus is conveyed by the operator to the checkout apparatus to prompt the customer to execute the checkout processing. In this way, an operation of conveying the registered basket to the checkout apparatus is widely used to enable the customer to grasp the checkout apparatus for use, to improve the serviceability by moving the registered basket by the operator, and to prevent unfair practice such as conveying the registered basket without executing checkout by the checkout apparatus.

On the other hand, moving the registered basket is a heavy burden on the operator temporally and physically. Specifically, the movement to a checkout apparatus located relatively far away from the operator is a heavy burden at the busy time and the like. It also takes much time and labor for the operator to confirm whether the registered basket is moved without mistake to the checkout apparatus which executes the checkout processing.

### DESCRIPTION OF THE DRAWINGS

FIG. 1 is a pattern view illustrating the whole of a checkout system according to a first embodiment;

FIG. 2 is a perspective view illustrating the appearance of a commodity data registration apparatus;

FIG. 3 is a perspective view illustrating the appearance of a basket moving body;

FIG. 4 is a perspective view illustrating the appearance of a checkout apparatus;

FIG. 5 is a block diagram illustrating the hardware structures of the commodity data registration apparatus and the checkout apparatus;

FIG. 6 is a block diagram illustrating the functional components of the commodity data registration apparatus and the checkout apparatus;

FIG. 7 is a flowchart illustrating the flow of a commodity sales registration processing executed by the commodity data registration apparatus;

FIG. 8 is a front view illustrating an example of a transfer destination selection screen;

FIG. 9 is a front view illustrating an example of a notification screen;

FIG. 10 is a diagram illustrating an example of the movement of a shopping basket by a basket moving body;

FIG. 11 is a flowchart illustrating the flow of a checkout processing executed by the checkout apparatus;

FIG. 12 is a pattern view illustrating another example of the whole of the checkout system;

FIG. 13 is a modification of the flowchart illustrating the flow of the commodity sales registration processing executed by the commodity data registration apparatus;

FIG. 14 is perspective view illustrating the appearance of a basket moving body according to a second embodiment; and

FIG. 15 is a diagram illustrating an example of the movement of a shopping basket by the basket moving body.

### DETAILED DESCRIPTION

In accordance with an embodiment, a checkout system comprises a commodity data registration apparatus configured to execute a commodity sales registration processing; a table configured to temporarily place a registered basket including a registered commodity after the commodity sales registration processing; a first checkout apparatus arranged next to the table and configured to execute a checkout processing based on data relating to the commodity sales registration processing selectively sent from the commodity data registration apparatus; a second checkout apparatus arranged next to the first checkout apparatus and configured to execute a checkout processing based on data relating to the commodity sales registration processing selectively sent from the commodity data registration apparatus; and a recognition module configured to recognize that the registered basket is positioned for the first checkout apparatus or the second checkout apparatus which is a transmission destination of the data.

### First Embodiment

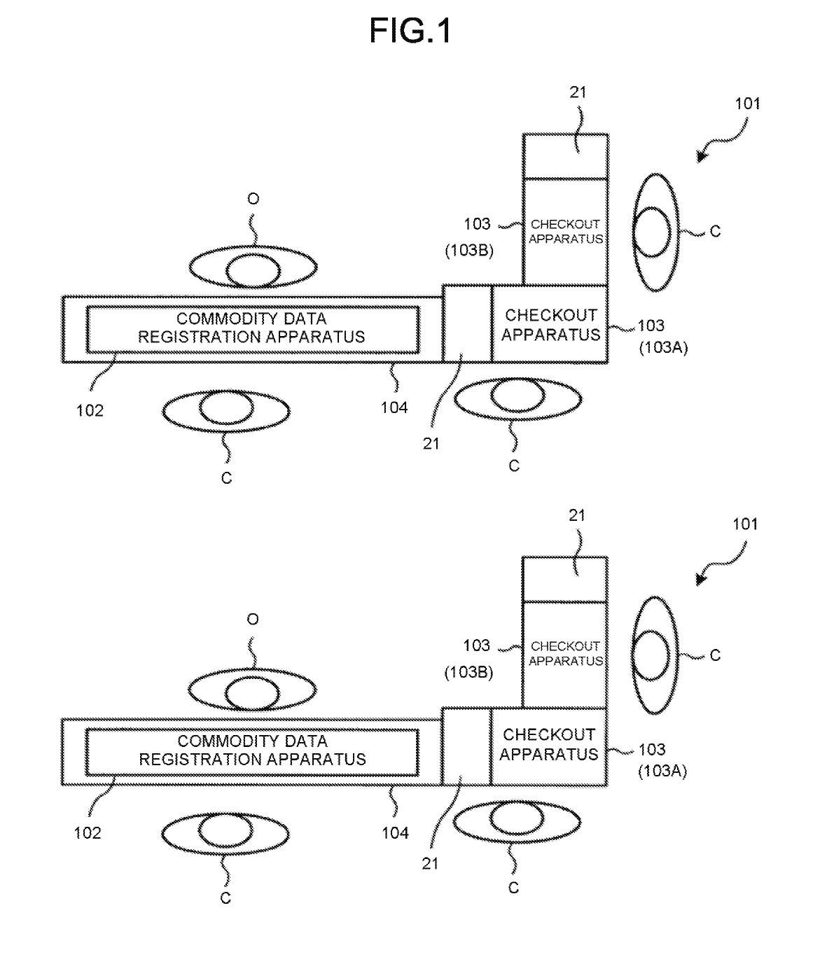

FIG. 1 is a pattern view illustrating the whole of a checkout system 101 according to the first embodiment. As shown in FIG. 1, the checkout system 101 includes a commodity data registration apparatus 102 operated by an operator O which is a checker (store clerk), and a checkout apparatus 103 operated by a customer C. The commodity data registration apparatus 102 is arranged on a working table 104 of a horizontally elongated table shape.

Two checkout apparatuses 103 are provided for one commodity data registration apparatus 102. One checkout apparatus (first checkout apparatus) 103A is linearly installed (in a processing direction of a commodity sales registration processing in the commodity data registration apparatus 102) in proximity to the working table 104. The other checkout apparatus (second checkout apparatus) 103B is positioned in proximity to the checkout apparatus 103A on the side where the operator O of the commodity data registration apparatus 102 is present, and is installed away from the working table 104. The other checkout apparatus 103B is installed in a state (in a direction orthogonal to the processing direction of the commodity sales registration processing) of being rotated by 90 degrees with respect to the one checkout apparatus 103A. In other words, the working table 104 including the commodity data registration apparatus 102 and the two checkout apparatuses 103 form an L shape. The reason why the two checkout apparatuses 103 are provided in a state of being rotated by 90 degrees is that the customers C do not line up side by side at the time of a checkout processing executed by the checkout apparatus 103. As shown in FIG. 1, in the present embodiment, a passage of the customer C is formed between a plurality of working tables 104.

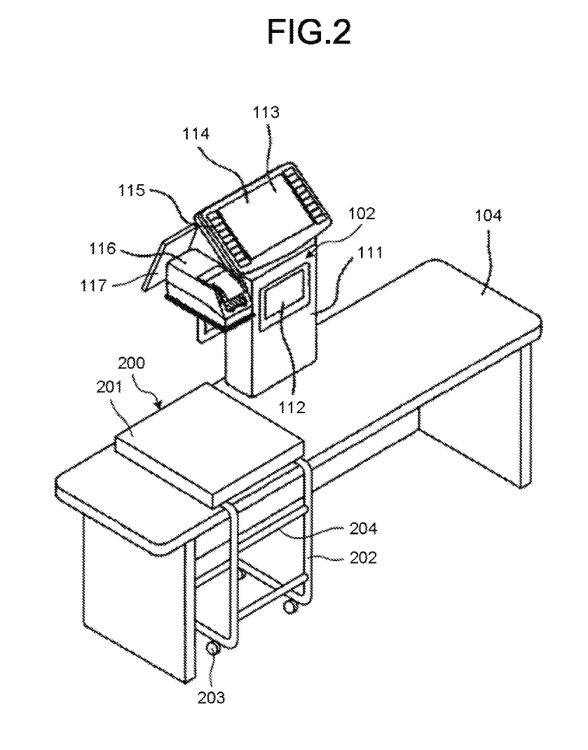

First, the commodity data registration apparatus 102 is described. FIG. 2 is a perspective view illustrating the appearance of the commodity data registration apparatus 102. As shown in FIG. 2, the commodity data registration apparatus 102 installed on an upper surface of the working table 104 is arranged on a vertical type scanner 111 having a reading window 112 as a base. The scanner 111 arranges an image capturing section (not shown) on the rear side of the reading window 112.

The commodity data registration apparatus 102 includes a display device 114 with a touch panel 113 and a keyboard 115 on the top of the scanner 111. The display device 114 displays a commodity name and a price of a commodity photographed by the image capturing section of the scanner 111. The touch panel 113 and the keyboard 115 assist input of commodity data.

On the left side of the commodity data registration apparatus 102 as viewed from the operator O side, a printer 116 is provided. The printer 116 issues a receipt on which identification data described later and transaction data such as a total amount of one transaction are printed.

In addition, on the left side of the commodity data registration apparatus 102 as viewed from the operator O side, a customer side display device 117 for the customer C is provided.

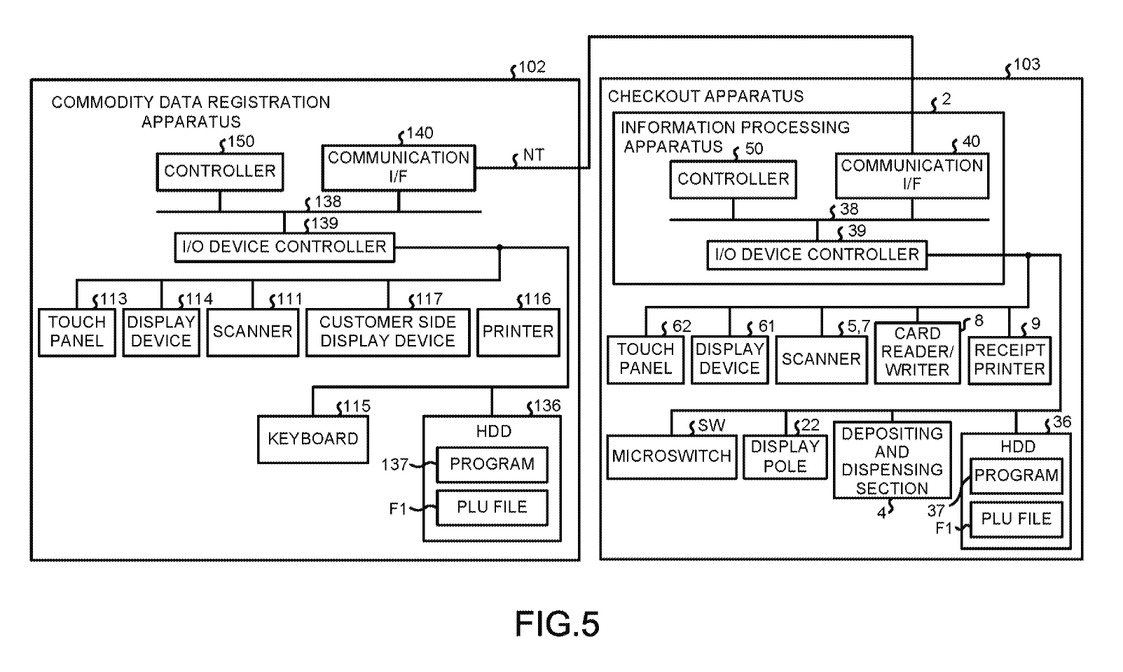

In the commodity data registration apparatus 102, by referring to a PLU file F1 (refer to FIG. 5), the commodity included in an image captured by the image capturing section is specified by reading of code information such as a barcode or a QR code (registered trademark) attached to the commodity or by generic object recognition.

The recognition of an object contained in an image is referred to as a general object recognition, which is realized by using the technologies that are illustrated in the following document.

YANAI KEIJI, “The current state and further directions on Generic Object Recognition”, in Proceedings of Information Processing Society of Japan, Vol. 48, No SIG 16, In URL:http://mm.cs.uec.ac.jp/IPSJ-TCVIM-Yanai.pdf [retrieved on Jan. 6, 2014].

Next, the commodity data registration apparatus 102 displays a screen for receiving confirmation of a specified commodity or an input such as a number on the display device 114. Based on the information such as a commodity code and input number of the commodity of which confirmation input is received, the commodity data registration apparatus 102 stores information relating to sales registration of a commodity category, a commodity name, a unit price, etc. of a commodity corresponding to the commodity code as sales data in a sales master file (not shown) to execute a sales registration operation.

Furthermore, as shown in FIG. 2, in the present embodiment, a basket moving body 200 of a cart shape capable of superimposing a basket receiving table 201 of a flat plate shape on the upper surface of the working table 104 is provided.

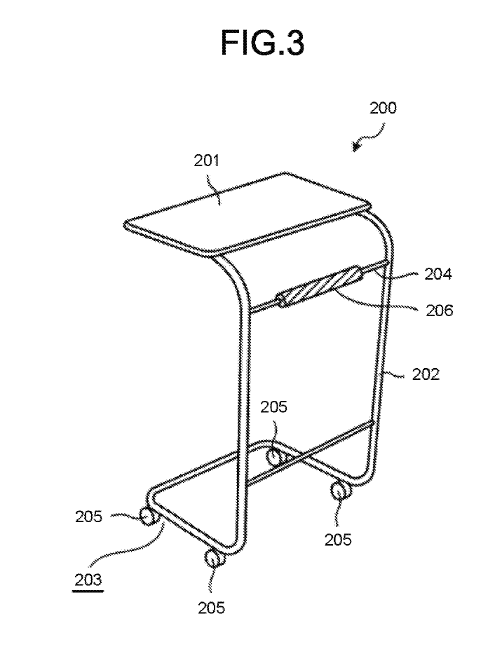

FIG. 3 is a perspective view illustrating the appearance of the basket moving body 200. As shown in FIG. 3, the basket moving body 200 roughly includes the basket receiving table 201, a frame 202 for supporting the basket receiving table 201, and a caster section 203 for movement arranged at the lowermost part of the frame 202 and a handle section 204 which is connected to the frame 202 and is gripped by the operator O at the time of moving the basket moving body 200. In other words, the basket moving body 200 is a moving cart that can be moved forward or backward by the operator O through gripping the handle section 204 by hand.

The basket receiving table 201 is a flat plate shape capable of placing a shopping basket including a registered commodity to which a series of the commodity sales registration processing is completed in the commodity data registration apparatus 102.

The frame 202 constitutes a skeleton of the whole basket moving body 200 and is made of a round bar shaped metal. The frame 202 is formed in a substantially U shape if viewed from a side. The frame 202 is provided with the basket receiving table 201 at the uppermost part thereof and the caster section 203 at the lowermost part thereof. Furthermore, the handle section 204 is mounted at the upper part of the frame 202. In other words, the basket moving body 200 has a shape which is largely opened between the basket receiving table 201 and the caster section 203 on the side (referred to as a front end side) opposite to a side where the handle section 204 is provided.

The caster section 203 has four wheels 205 at the lowermost parts of the frame 202. The handle section 204 is provided with a grip 206 gripped by the operator O at the time of movement.

The height position of the uppermost part of the frame 202 where the basket receiving table 201 is arranged is set to be slightly higher than the height position of the upper surface of the working table 104. As described above, as the basket moving body 200 has a shape which is largely opened between the basket receiving table 201 on the front end side and the caster section 203, if the front end side of the basket moving body 200 is moved towards the working table 104, the basket moving body 200 can be further moved without interfering with the working table 104.

If the basket moving body 200 is moved without any change, the frame 202 eventually abuts against the working table 104 and stops. In this state, as shown in FIG. 2, the basket receiving table 201 of the basket moving body 200 is superimposed on the working table 104.

In the state shown in FIG. 2, the basket receiving table 201 of the basket moving body 200 is positioned above the upper surface of the working table 104. Therefore, it is desirable to reduce the thicknesses of the basket receiving table 201 and the frame 202 to such a degree that the basket receiving table 201 and the frame 202 can withstand the weight of the shopping basket into which the registered commodity is input. In this way, as it is possible to enable the height position of the shopping basket placed on the basket receiving table 201 to be close to that of the shopping basket in a case where the shopping basket is directly placed on the working table 104, it is possible to facilitate the series of the commodity sales registration processing in the commodity data registration apparatus 102 described later.

In the present embodiment, the basket receiving table 201 has a flat plate shape, but the present invention is not limited thereto. For example, protruding members protruding from the upper surface of the basket receiving table 201 may be provided on a part or all of the four sides forming the upper surface of the basket receiving table 201. By providing the protruding members on the basket receiving table 201 in this way, it is possible to prevent the shopping basket from dropping out of the basket receiving table 201.

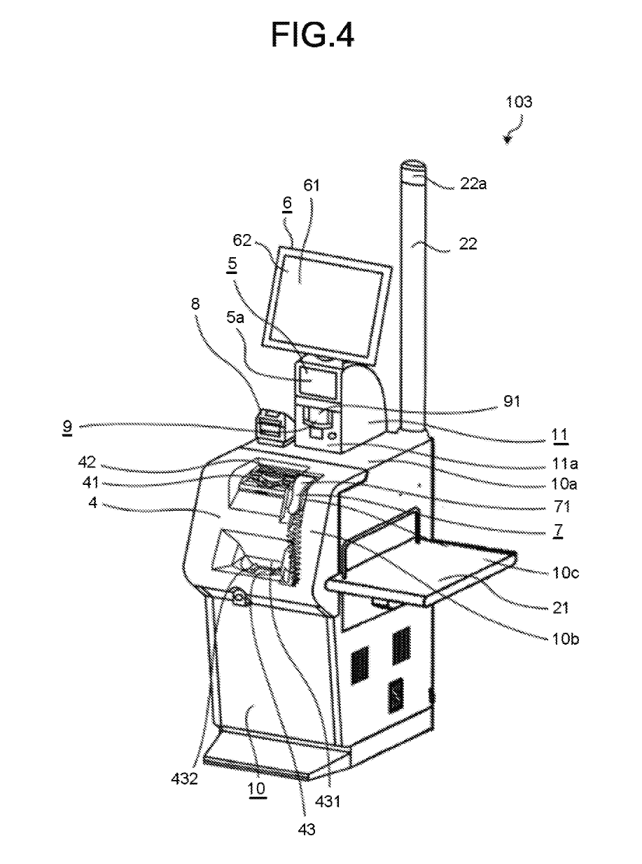

Next, the checkout apparatus 103 is described. FIG. 4 is a perspective view illustrating the appearance of the checkout apparatus 103. The checkout apparatus 103 of the present embodiment in an idle state can also function as a self-checkout POS (Point Of Sales) terminal with which the customer C can execute a commodity registration operation and a checkout operation.

The checkout apparatus 103 includes an information processing apparatus 2 (refer to FIG. 5), a depositing and dispensing section 4, a fixed scanner 5, a display and operation panel 6, a handy scanner 7, a card reader/writer 8, a receipt printer 9, a first housing 10 and a second housing 11. The first housing 10 is a box that contains the information processing apparatus 2 and the depositing and dispensing section 4 therein and is placed on a floor. The second housing 11 is an outer shell of the fixed scanner 5 and the receipt printer 9 and is placed on an upper surface 10a of the first housing 10.

The fixed scanner 5 includes an image capturing window 5a provided at the upper part of the first housing 10 and the image capturing section (not shown) built in the first housing 10. The image capturing section captures a code symbol image such as a barcode held in front of the image capturing window 5a, and decodes the captured code symbol image. Then, the image capturing section outputs the decoded code information to the information processing apparatus 2. If the generic object recognition is performed, the image capturing section outputs a commodity image obtained by photographing a commodity held in the front of the image capturing window 5a to the information processing apparatus 2.

The handy scanner 7 is provided at the upper part of a front surface 10b of the first housing 10. A holding section 10c for holding a front end 71 of the handy scanner 7 in a hooked state is provided at the upper right part of the front surface 10b of the first housing 10.

The display and operation panel 6 includes a display device 61 and a touch panel 62 and is mounted on the second housing 11. The display device 61 displays an image under the control of the information processing apparatus 2. The touch panel 62 is provided on the surface of the display device 61 and outputs information based on a position touched by the customer C to the information processing apparatus 2.

The card reader/writer 8 is arranged next to the second housing 11 and is arranged on the upper surface 10a of the first housing 10. The card reader/writer 8 reads and writes information from and to a magnetic card (information recording medium) such as a point card or a credit card.

The depositing and dispensing section 4 includes a cash insertion port 41, a bill dispensing port 42, and a coin dispensing section 43. The coin dispensing section 43 is provided with a dispensing port 431 and a receiving tray 432. The depositing and dispensing section 4 receives bills and coins inserted into the cash insertion port 41 to separately store them. In response to a request from the information processing apparatus 2, the depositing and dispensing section 4 dispenses change from the dispensing port 431. The receiving tray 432 catches the dispensed change.

The receipt printer 9 has a printing section (not shown) built in the second housing 11 and a receipt issuing port 91 provided on a front surface 11a of the second housing 11. Under the control of the information processing apparatus 2, the receipt printer 9 issues a receipt printed by the printing section from the receipt issuing port 91.

The information processing apparatus 2 is built in the first housing 10, and collectively controls each section (the depositing and dispensing section 4, the fixed scanner 5, the display and operation panel 6, the handy scanner 7, the card reader/writer 8, and the receipt printer 9) of the checkout apparatus 103. The information processing apparatus 2 acquires the code information and the commodity image from the fixed scanner 5 or the handy scanner 7. The information processing apparatus 2 outputs information displayed on the display device of the display and operation panel 6, and acquires information on an operation executed by the customer C from the touch panel 62. Furthermore, the information processing apparatus 2 grasps the depositing to the depositing and dispensing section 4 and instructs the depositing and dispensing section 4 to dispense the change.

The checkout apparatus 103 has a basket placing table 21 on one side of the first housing 10. The basket placing table 21 is a storage table which is a storage place of the shopping basket at the time the customer C executes the checkout processing. The height position of the upper surface of the basket placing table 21 is substantially coincident with the height position of the upper surface of the working table 104 where the commodity data registration apparatus 102 is installed. Moreover, the basket placing tables 21 can be selectively installed on both sides of the first housing 10.

The basket placing table 21 has a microswitch SW (refer to FIG. 5) on the upper surface thereof. The microswitch SW is a detection module for detecting that the shopping basket (registered basket) including the commodity to which the commodity sales registration processing is already executed is placed on the basket placing table 21 or that the basket receiving table 201 of the basket moving body 200 is superimposed on the basket placing table 21. The detection module is not limited to the microswitch SW. For example, IC tags are attached to the shopping basket (the registered basket) and the basket receiving table 201 of the basket moving body 200, and a small antenna is provided in the basket placing table 21. Then, by using RFID (Radio Frequency IDentification) technology, reading of the IC tags by the small antenna may be assumed as the detection that the shopping basket is placed on the basket placing table 21 or the like. The detection module may be an image sensor. The image sensor, for example, recognizes that the shopping basket is placed on the basket placing table 21 by image recognition.

Furthermore, in the checkout apparatus 103, a display pole 22 as a notification section for displaying a current state of the checkout apparatus 103 is vertically arranged on the upper surface of the first housing 10. The display pole 22 has a light emitting section 22a that selectively emits blue light and red light at the front end thereof.

Next, the hardware structures of the commodity data registration apparatus 102 and the checkout apparatus 103 are described. FIG. 5 is a block diagram illustrating the hardware structures of the commodity data registration apparatus 102 and the checkout apparatus 103.

As shown in FIG. 5, the commodity data registration apparatus 102 includes a controller 150 having a computer structure composed of a CPU (Central Processing Unit), a ROM (Read Only Memory) and a RAM (Random Access Memory). The ROM stores various programs executed by the CPU and various data. The RAM temporarily stores data and programs at the time the CPU executes various programs and also stores sales data indicating sales records of the commodities and various screen display data displayed on the display device 114.

The controller 150 controls I/O devices such as the scanner 111, the touch panel 113, the display device 114, the keyboard 115, the printer 116, the customer side display device 117 and an HDD (Hard Disk Drive) 136 via an I/O (Input/Output) device controller 139 and a bus line 138, and controls the entire system of the commodity data registration apparatus 102.

A program 137 executable by the CPU of the controller 150 and a PLU file F1 are stored in the HDD 136 which is a storage module. The PLU file F1 stores the commodity code uniquely assigned to each commodity in association with information relating to the commodity such as the commodity name, the price, the commodity category and the like. If the commodity is specified by the generic object recognition, the PLU file F1 also stores feature amount such as tint and unevenness of the surface read from the commodity image.

The program 137 executed by the CPU of the controller 150 of the commodity data registration apparatus 102 is recorded in a computer-readable recording medium such as CD-ROM, an FD (flexible disk), a CD-R, a DVD (Digital Versatile Disk) or the like in a form of an installable or an executable file to be provided.

Further, the program 137 executed by the CPU of the controller 150 of the commodity data registration apparatus 102 is stored in a computer connected with a network such as an Internet and may be downloaded via the network to be supplied. The program 137 executed by the CPU of the controller 150 of the commodity data registration apparatus 102 may be supplied or distributed via the network such as the Internet.

The controller 150 can mutually communicate with a store server (not shown) and the checkout apparatus 103 connected via a network NT such as a LAN (Local Area Network) via the communication I/F 140.

The store server generally manages the commodity sales registration processing executed by one or a plurality of the commodity data registration apparatuses 102 installed in the store and the checkout processing executed by the checkout apparatus 103.

On the other hand, as shown in FIG. 5, the checkout apparatus 103 includes a controller 50 having a computer structure composed of a CPU and a ROM and a RAM (not shown) which are storage media to the information processing apparatus 2. The ROM stores various programs executed by the CPU and various data. The RAM temporarily stores data and programs at the time the CPU executes various programs and also stores sales data indicating sales records of commodities and various screen display data displayed on the display device 61.

The controller 50 controls I/O devices such as the touch panel 62, the display device 61, the fixed scanner 5, the handy scanner 7, the card reader/writer 8, the receipt printer 9, the depositing and dispensing section 4, the display pole 22, an HDD 36 and the micro switch SW via the I/O device controller 39 and the bus line 38, and controls the entire system of the checkout apparatus 103.

The card reader/writer 8 reads information in a point card or a credit card of the customer inserted from a card insertion slot. The receipt printer 9 prints a receipt after the checkout processing and issues it from the receipt issuing port 91. The depositing and dispensing section 4 processes bills and coins inserted into the cash insertion port 41. The depositing and dispensing section 4 dispenses the change from the dispensing port 431 in response to the request.

The HDD 36 which is the storage module stores a program 37 executable by the controller 50 and the PLU file F1.

The program 37 executed by the CPU of the controller 50 of the checkout apparatus 103 is recorded in a computer-readable recording medium such as a CD-ROM, an FD (flexible disk) , a CD-R, a DVD (Digital Versatile Disk) or the like in a form of an installable or an executable file to be provided.

Further, the program 37 executed by the CPU of the controller 50 of the checkout apparatus 103 is stored in a computer connected with a network such as the Internet and may be downloaded via the network to be supplied. The program 37 executed by the CPU of the controller 50 of the checkout apparatus 103 may be supplied or distributed via the network such as the Internet.

The controller 50 can mutually communicate with a store server (not shown) and the commodity data registration apparatus 102 connected via the network NT such as the LAN (Local Area Network) via the communication I/F 40.

Next, the flow of a series of processing in the checkout system 101 is described.

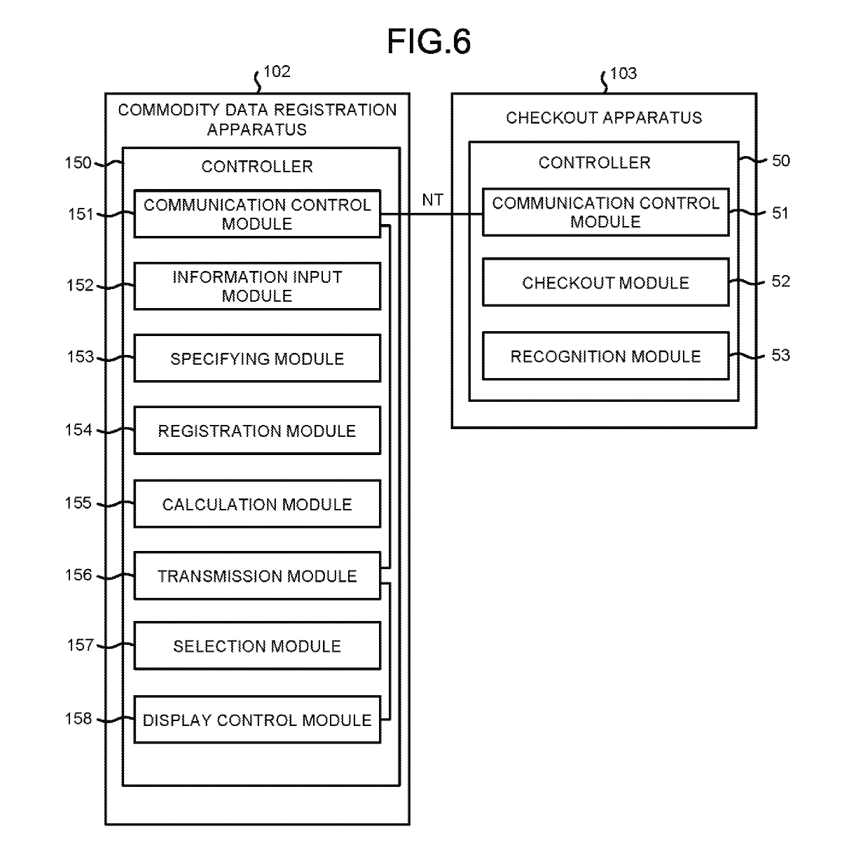

First, functional components realized by execution of the program 137 by the CPU of the controller 150 of the commodity data registration apparatus 102 and functional components realized by execution of the program 37 by the CPU of the controller 50 of the checkout apparatus 103 are described with reference to FIG. 6.

FIG. 6 is a block diagram illustrating the functional components of the commodity data registration apparatus 102 and the checkout apparatus 103. As shown in FIG. 6, the controller 150 of the commodity data registration apparatus 102 executes the program 137 stored in the HDD 136 to function as a communication control module 151, an information input module 152, a specifying module 153, a registration module 154, a calculation module 155, a transmission module 156, a selection module 157, and a display control module 158.

Similarly, the controller 50 of the checkout apparatus 103 executes the program 37 stored in the HDD 36 to function as a communication control module 51, a checkout module 52 and a recognition module 53.

The communication control module 151 controls communication with the checkout apparatus 103 connected via the network NT such as the LAN via the communication I/F 140.

The information input module 152 inputs identification information for identifying various commodities. More specifically, the information input module 152 inputs the code information and the commodity image outputted from the scanner 111 as the identification information.

If the identification information is input, the specifying module 153 specifies the commodity based on the identification information. More specifically, if the code information is input from the scanner 111, the specifying module 153 refers to the PLU file F1 to specify the commodity corresponding to the commodity code. If the commodity image is input from the scanner 111, the specifying module 153 specifies the commodity by the generic object recognition for recognizing the object included in the image.

The registration module 154 registers sales data indicating the content relating to a commercial transaction with respect to the specified commodity. More specifically, based on the information such as the commodity code and the input number of the specified commodity, the registration module 154 acquires information relating to the sales registration such as the commodity category, the commodity name, the unit price and the like of the commodity corresponding to the commodity code from the PLU file F1 and sets the information as the sales data.

If there is an input of a closing operation (for example, press on a subtotal key (not shown)) from the touch panel 113 or the keyboard 115 and closing of the commercial transaction is declared, the calculation module 155 calculates a total amount relating to one transaction based on the registered sales data.

The transmission module 156 transmits the registered sales data and the calculated total amount to the checkout apparatus 103 via the communication control module 151.

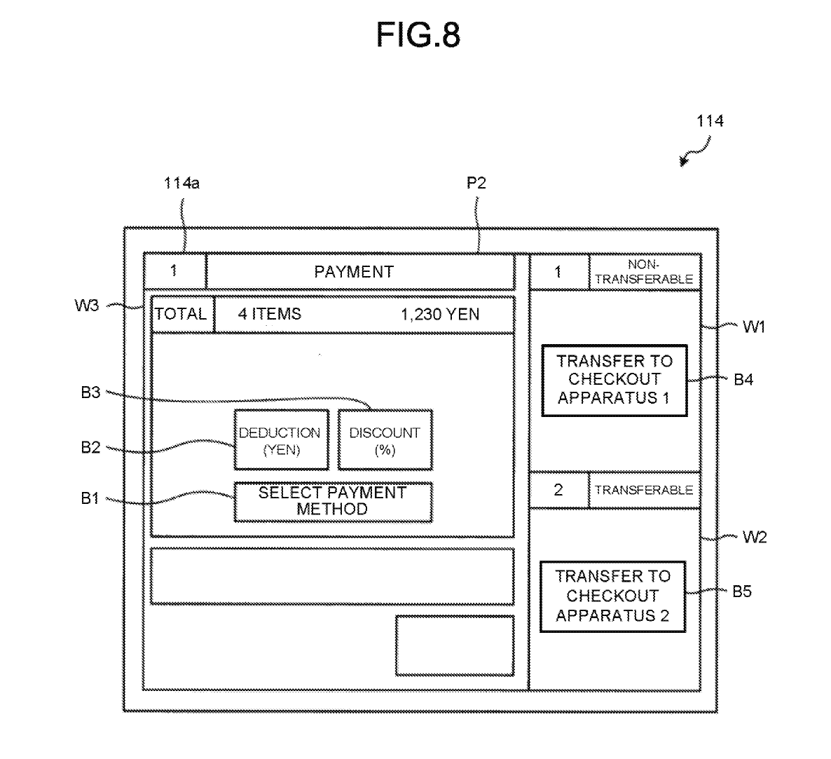

The selection module 157 selects one checkout apparatus 103 if there is a plurality of the checkout apparatuses 103 connected to the network. Therefore, the transmission module 156 transmits the registered sales data and the calculated total amount to one checkout apparatus 103 selected by the selection module 157. Such a selection module 157 displays a transfer destination selection screen P2 (refer to FIG. 8) for receiving the selection of the checkout apparatus 103 as a transfer destination on the display device 114, and receives the selection of the one checkout apparatuses 103 according to the operation on the selection screen.

At the time of transmission by the transmission module 156, the display control module 158 displays information indicating the checkout apparatus 103 as a transmission destination and the total amount on the display device 114 or the customer side display device 117.

Further, the communication control module 51 controls communication with the commodity data registration apparatus 102 connected via the network NT such as the LAN via the communication I/F 40.

The checkout module 52 executes the checkout processing based on the sales data which is transmitted from the commodity data registration apparatus 102 and indicates the content of the commercial transaction about the specified commodity and the total amount relating to the one transaction calculated based on the sales data.

The recognition module 53 confirms that the registered basket or the basket moving body 200 with the registered basket placed thereon is positioned in the checkout apparatus 103 to which the sales data and the total amount as the transaction data are transmitted.

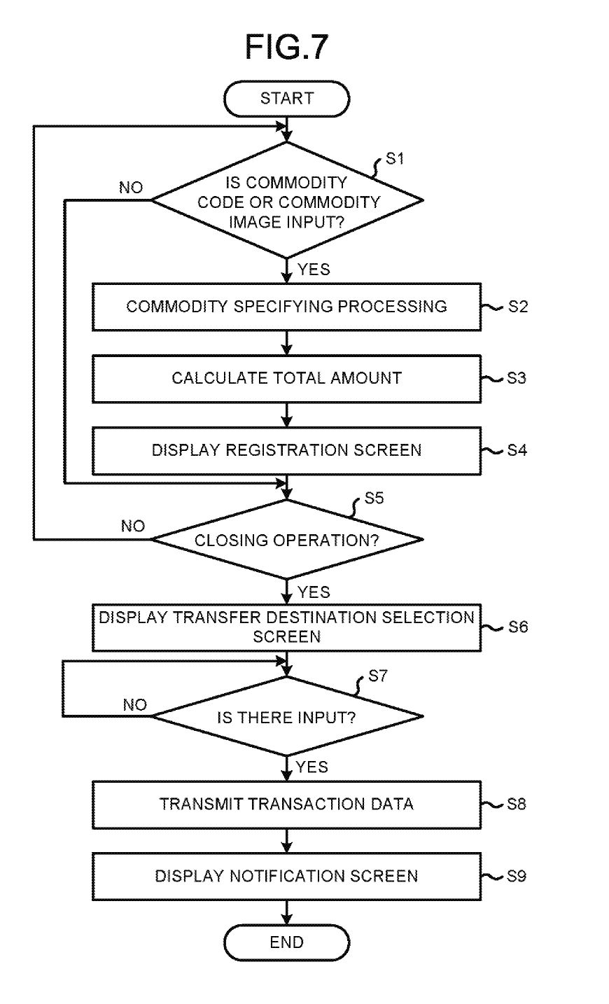

Next, the operation of the checkout system 101 is described in detail. First, the operation of the commodity data registration apparatus 102 is described. FIG. 7 is a flowchart illustrating the flow of the commodity sales registration processing executed by the commodity data registration apparatus 102.

As shown in FIG. 7, if it is determined that the commodity code or the commodity image obtained from the image captured by the image capturing section of the scanner 111 is input (Yes in Act S1), the controller 150 (the information input module 152 and the specifying module 153) of the commodity data registration apparatus 102 executes a commodity specifying processing for specifying the commodity by retrieving the PLU file F1 based on the feature amount of the commodity code and the commodity image (Act S2).

The controller 150 (the registration module 154 and the calculation module 155) of the commodity data registration apparatus 102 reads out the commodity information such as the commodity code, the commodity name, the unit price, etc. of the specified commodity from the PLU file F1, stores the read commodity information and a commodity quantity input via the touch panel 113 or the keyboard 115 in a work area of the RAM to register them, and adds the amount based on the read unit price and the input commodity quantity to calculate the total amount to store the total amount in the work area of the RAM (Act S3).

Thereafter, the controller 150 (registration module 154) of the commodity data registration apparatus 102 displays the read commodity information and the calculated total amount which are stored in the work area of the RAM as a registration screen on the display device 114 (Act S4). The registered commodity to which the commodity registration is already executed as described above is inserted into the shopping basket (not shown) placed on the left side of the commodity data registration apparatus 102 as seen from the operator O side. In the present embodiment, the shopping basket is placed on the basket receiving table 201 of the basket moving body 200 superimposed on the working table 104 as shown in FIG. 2.

The processing in Act S1 to Act S4 described above is repeated until the closing operation (for example, press on the subtotal key (not shown)) is input from the touch panel 113 or the keyboard 115 (No in Act S5).

If it is determined that the closing operation is input from the touch panel 113 or the keyboard 115 (Yes in Act S5), the controller 150 (selection module 157) of the commodity data registration apparatus 102 displays a transfer destination selection screen P2 (refer to FIG. 8) for selecting the checkout apparatus 103 as the transfer destination of the transaction data of one transaction on the display device 114 (Act S6).

FIG. 8 is a front view illustrating an example of the transfer destination selection screen P2. As shown in FIG. 8, the controller 150 of the commodity data registration apparatus 102 controls the display device 114 to display the transfer destination selection screen P2 on which a payment amount display window W3, a first transfer destination window W1 and a second transfer destination window W2 smaller than the payment amount display window W3 which are displayed in a display area 114a of the display device 114 are defined in advance. The payment amount display window W3 is provided close to the left end in the display area 114a, occupies half or more of the width of the display area 114a and has a height respectively adjacent to the upper side and the lower side in the display area 114a. The first transfer destination windows W1 and the second transfer destination window W2 are provided vertically adjacent to each other between a right end side of the display area 114a and a right end side of the payment amount display window W3.

In the payment amount display window W3, the total amount and the total commodity quantities at the time point of input of the closing operation are displayed. In the payment amount display window W3, a button B1 for selecting a payment method, a button B2 for subtotal deduction and a button B3 for subtotal discount are provided.

On the other hand, in the first transfer destination window W1 and the second transfer destination window W2, for each of the checkout apparatuses 103 which are candidates of the transfer destination, transfer execution information indicating that the checkout apparatuses 103 is in a transferrable state or in a non-transferrable state at the current time point is added with identification number of each checkout apparatus 103 to be displayed, and buttons B4 and B5 for declaring the transfer are provided. Herein, if the checkout processing is being executed, it is displayed that the checkout apparatus 103 which is executing the checkout processing is in the non-transferrable state; however, the operations on the buttons B4 and B5 for declaring the transfer are enabled. This is because the checkout processing is completed in a short time, and the checkout apparatus 103 can be switched to the transferrable state immediately.

The method of selecting the checkout apparatus 103 as the transfer destination is not limited to the operation on the buttons B4 and B5. For example, the checkout apparatus 103 which becomes the transfer destination may be selected by a combination operation of a numeric key and a transmission key provided on the keyboard 115. Specifically, the checkout apparatus 103 associated with the first transfer destination window W1 can be selected by a combination operation of “1” of the numeric key and the transmission key.

It is possible to optionally designate the identification number of the checkout apparatus 103 which becomes the transfer destination by the combination operation of the numeric key and the transmission key provided on the keyboard 115 in this manner, and thus, it is possible to transfer transaction data to other checkout apparatuses 103 except the previously designated checkout apparatus 103.

If it is determined that the operation of the button B4 of the first transfer destination window W1 or the button B5 of the second transfer destination window W2 is input via the touch panel 113 (Yes in Act S7), the controller 150 (the selection module 157, the transmission module 156 and the communication control module 151) of the commodity data registration apparatus 102 transmits the commodity information, the commodity quantity, the total amount and the total commodity quantities stored in the work area of the RAM thus far as the transaction data of one transaction to the selected checkout apparatus 103 (Act S8).

Before operating the button B4 of the first transfer destination window W1 or the button B5 of the second transfer destination window W2, if the button B2 for subtotal deduction and the button B3 for subtotal discount of the payment amount display window W3 is operated, a balance after the subtotal deduction or the subtotal discount for the total amount stored in the work area of the RAM is also sent to the selected checkout apparatus 103.

The controller 150 of the commodity data registration apparatus 102 may also include identification data capable of specifying the transaction in transaction data for one transaction. The identification data is unique data capable of identifying one transaction for each transaction according to the total amount of one transaction, the unique number of the commodity data registration apparatus 102 executing the commodity sales registration processing to the transaction commodity, and date and time at which the commodity sales registration processing is executed.

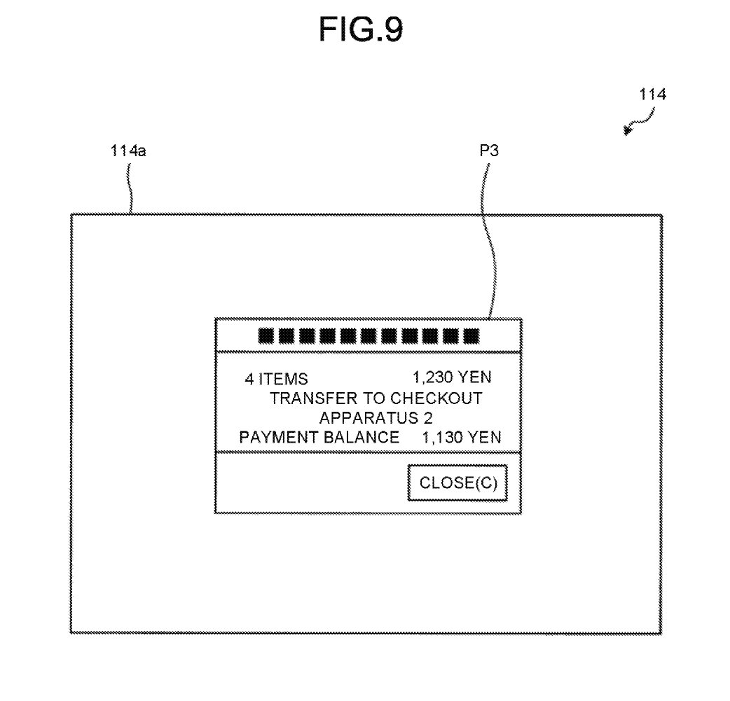

Finally, the controller 150 (the display control module 158) of the commodity data registration apparatus 102 displays a notification screen P3 (refer to FIG. 9) for informing that the transaction data is transmitted to the desired checkout apparatus 103 on the display device 114 (Act S9) and then terminates a series of the commodity sales registration processing.

FIG. 9 is a front view illustrating an example of the notification screen P3. As shown in FIG. 9, the controller 150 of the commodity data registration apparatus 102 displays the notification screen P3 indicating that the transaction data is transferred to the desired checkout apparatus 103 on the display device 114. In the notification screen P3, the total amount and the total commodity quantities are displayed. If the subtotal deduction or the subtotal discount is executed, the balance after the subtotal deduction or the subtotal discount is also displayed.

The controller 150 of the commodity data registration apparatus 102 displays the notification screen P3 on the display device 114 provided on the operator side; however, the present invention is not limited to this. The notification screen P3 may also be displayed on the customer side display device 117. By displaying the notification screen P3 on the customer side display device 117 provided on the customer side in this way, it is possible to inform the customer that the transaction data is transferred to the checkout apparatus 103. In addition, the checkout apparatus 103 to which the transaction data is transferred can inform the operator and the customer of the checkout apparatus 103 to which the shopping basket is supposed to be moved by blinking the light emitting section 22a of the display pole 22.

In this way, if the series of the commodity sales registration processing in the commodity data registration apparatus 102 is terminated, the shopping basket (hereinafter, referred to as the registered basket) containing the commodity to which the commodity sales registration processing is already executed is conveyed by the operator O to the checkout apparatus 103 to urge the customer to execute the checkout processing. In this way, the operation of conveying the registered basket to the checkout apparatus 103 by the operator O is widely used to enable the customer C to grasp the checkout apparatus 103 for use, to improve the serviceability by moving the registered basket by the operator O, and to prevent unfair practice such as conveying the registered basket without executing the checkout operation with the checkout apparatus 103.

If the checkout apparatus 103A installed linearly in proximity to the working table 104 is selected, the operator O moves the registered basket from the basket receiving table 201 of the basket moving body 200 onto the working table 104 and slides it on the working table 104 to move it to the basket placing table 21 of the checkout apparatus 103A. In this way, if the checkout apparatus 103A installed linearly in proximity to the working table 104 is selected, by merely sliding the registered basket on the working table 104, the registered basket can be moved onto the basket placing table 21 of the desired checkout apparatus 103A, so that the temporal and physical burden on the operator O is light.

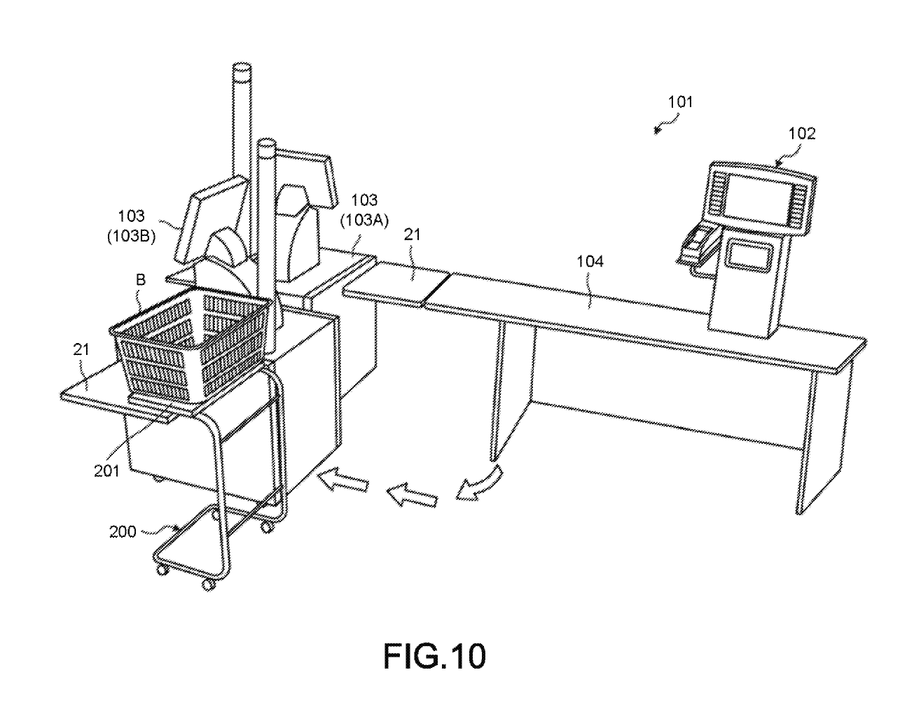

On the other hand, if the checkout apparatus 103B installed away from the working table 104 is selected, the operator O moves the basket moving body 200 with the registered basket placed thereon to the basket placing table 21 of the checkout apparatus 103B installed away from the working table 104. FIG. 10 is a diagram illustrating an example of the movement of the shopping basket by the basket moving body 200. As shown in FIG. 10, if the checkout apparatus 103B installed away from the working table 104 is selected, the operator O can move a registered basket B onto the basket placing table 21 of the desired checkout apparatus 103B simply by moving the basket moving body 200 with the registered basket B placed thereon. As a result, the temporal and physical burden on the operator O as the conventional case in which the operator O conveys the registered basket B by hand to move it to the distant checkout apparatus 103B is greatly reduced.

After confirming that the customer C finishes the checkout processing described later in the checkout apparatus 103B, the operator O moves the basket moving body 200 to an original position (a state in which the basket receiving table 201 is superimposed on the working table 104).

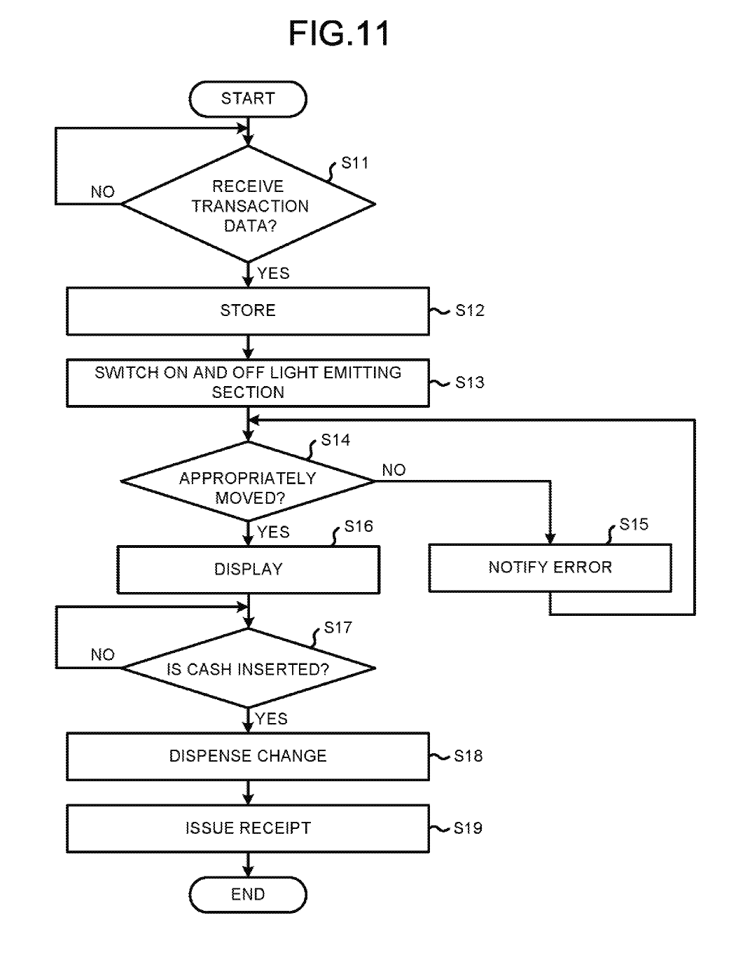

Next, the operation of the checkout apparatus 103 is described. FIG. 11 is a flowchart illustrating the flow of the checkout processing executed by the checkout apparatus 103.

As shown in FIG. 11, if receiving the transaction data from the commodity data registration apparatus 102 (Yes in Act S11), the controller 50 (communication control module 51) of the checkout apparatus 103 stores the received transaction data in the work area of the RAM (Act S12). The controller 50 of the checkout apparatus 103 blinks the light emitting section 22a of the display pole 22 (Act S13).

In addition, the controller 50 (recognition module 53) of the checkout apparatus 103 confirms whether or not the registered basket B is properly conveyed to the selected checkout apparatus 103 (Act S14).

In other words, if the checkout apparatus 103A is selected, the registered basket B is properly conveyed if the registered basket B is moved onto the basket placing table 21 of the checkout apparatus 103A. If the checkout apparatus 103B is selected, the registered basket B is properly conveyed if the basket moving body 200 with the registered basket B placed thereon is moved to the basket placing table 21 of the checkout apparatus 103B.

Specifically, if a certain time elapses after the microswitch SW of the basket placing table 21 is not turned on despite receiving the transaction data, the controller 50 (recognition module 53) of the checkout apparatus 103 determines that the registered basket B is not properly conveyed to the selected checkout apparatus 103 (No in Act S14). It is considered that the reason why the microswitch SW is not turned on even if a certain time elapses is that the registered basket is not conveyed to the selected checkout apparatus 103.

In this way, if it is determined that the registered basket B is not properly conveyed to the selected checkout apparatus 103 (No in Act S14), the controller 50 (recognition module 53) of the checkout apparatus 103 notifies an error indicating that “the registered basket B is not properly conveyed to the selected checkout apparatus 103” (Act S15) and returns to the processing in Act S14.

As a method of notifying an error, for example, the controller 50 of the checkout apparatus 103 enables the light emitting section 22a of the display pole 22 to emit the red light . If the light emitting section 22a of the display pole 22 emits the red light, the operator O may convey the registered basket B to the selected checkout apparatus 103 again.

On the other hand, if the microswitch SW is turned on within a certain time after the transaction data is received, the controller 50 (recognition module 53) of the checkout apparatus 103 determines that the registered basket B is properly conveyed to the selected checkout apparatus 103 (Yes in Act S14).

In this way, if it is determined that the registered basket B is properly conveyed to the selected checkout apparatus 103 (Yes in Act S14), the controller 50 (checkout module 52) of the checkout apparatus 103 displays the total amount (or the balance after the execution of the subtotal deduction or the subtotal discount) of one transaction included in the received transaction data on the display device 61 of the display and operation panel 6 (Act S16).

Thereafter, the controller 50 (checkout module 52) of the checkout apparatus 103 receives the input of the cash from the cash insertion port 41 of the depositing and dispensing section 4 (Act S17).

If the cash of the amount equal to or greater than the total amount (or the balance after the execution of the subtotal deduction or the subtotal discount) displayed on the display device is inserted from the cash insertion port 41 of the depositing and dispensing section 4 (Yes in Act S17), the controller 50 (checkout module 52) of the checkout apparatus 103 dispenses a difference obtained by subtracting the total amount (or the balance after the execution of the subtotal deduction or the subtotal discount) from the inserted amount as the change amount from the bill dispensing port 42 and the coin dispensing section 43 (Act S18).

The controller 50 (checkout module 52) of the checkout apparatus 103 controls the receipt printer 9 to issue the receipt on which the received transaction data, the inserted amount (deposit amount) and the change amount are printed from the receipt issue opening 91 (Act S19), and ends the checkout processing.

In this way, according to the checkout system 101 of the embodiment, it is possible to eliminate the checkout job from the work of the checker by eliminating the cost burden of the receipt paper at the store and saving the trouble of the customer.

According to the checkout system 101 of the embodiment, if the registered basket B is not properly conveyed to the selected checkout apparatus 103, an error indicating that “the registered basket is not appropriately conveyed to the selected checkout apparatus” is notified. Thus, it is possible to reliably execute the checkout job.

In the commodity data registration apparatus 102 of the present embodiment, as in the conventional case, the transaction data is temporarily retained in a store server or the like, and the receipt on which the identification data for identifying temporarily retained transaction data is printed can also be issued. In this case, a retaining key is provided in the display device 114 with the touch panel 113 or the keyboard 115, and the controller 150 of the commodity data registration apparatus 102 retains the transaction data if the retaining key is operated. The customer receives the receipt on which the identification data for identifying the transaction data temporarily retained at the commodity data registration apparatus 102 is printed. Then, the customer inputs the identification data printed on the receipt in the checkout apparatus 103 to call the retained transaction data from the store server or the like to perform the checkout processing.

In this way, even if there is an abnormality in the network between the commodity data registration apparatus 102 and the checkout apparatus 103, it is possible to omit the checkout job from the work of the checker (store clerk).

As described above, according to the present embodiment, if the checkout apparatus 103B installed away from the working table 104 is selected, the operator O can move the registered basket B onto the basket placing table 21 of the desired checkout apparatus 103B simply by moving the basket moving body 200 with the registered basket B placed thereon. As a result, the temporal and physical burden on the operator O as the conventional case in which the operator O conveys the registered basket B by hand to move it to the distant checkout apparatus 103B is greatly reduced.

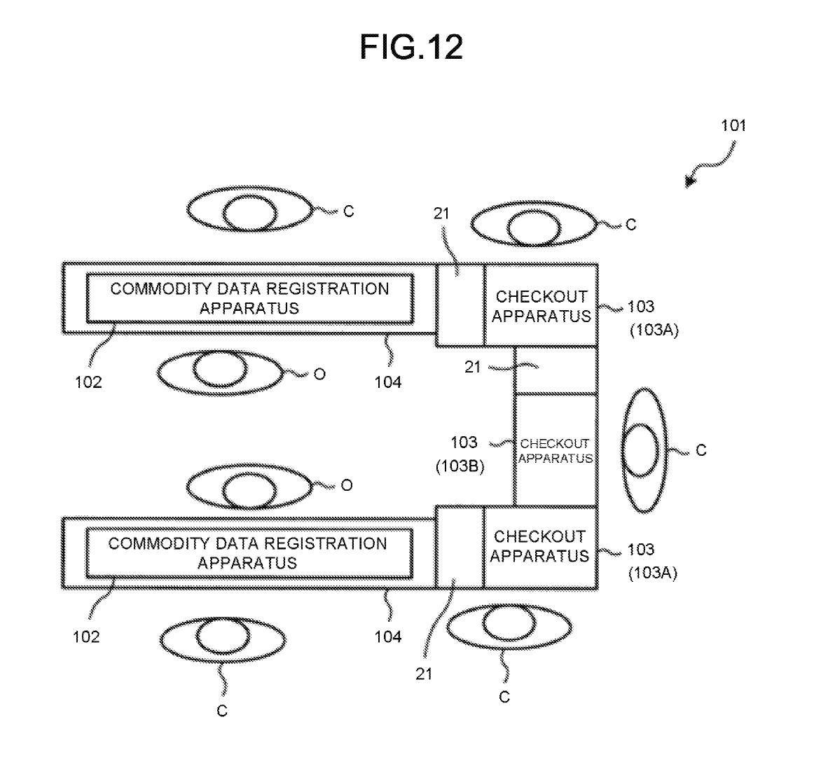

In the present embodiment, as shown in FIG. 1, two checkout apparatuses 103 are provided for one commodity data registration apparatus 102; however, the present invention is not limited to this. For example, as shown in FIG. 12, three checkout apparatuses 103 maybe provided for two commodity data registration apparatuses 102.

Furthermore, in the present embodiment, the basket receiving table 201 of the basket moving body 200 is provided to be superimposed on the upper surface of the working table 104; however, the present invention is not limited to that. For example, the working table 104 at the checkout apparatus 103A side is slightly shortened. Then, the basket receiving table 201 of the basket moving body 200 is positioned between the basket placing table 21 and the working table 104 of the checkout apparatus 103A. In this case, the position of the upper surface of the basket receiving table 201 of the basket moving body 200 is substantially coincident with the upper surface of the basket placing table 21 and the upper surface of the working table 104. In other words, the basket moving body 200 is a part of the working table 104 or the basket placing table 21 of the checkout apparatus 103A. In this way, if the checkout apparatus 103B installed away from the working table 104 is selected, by moving the basket moving body 200 with the shopping basket subjected to the commodity registration operation placed thereon, the shopping basket to which the commodity registration is already executed can be moved onto the basket placing table 21 of the desired checkout apparatus 103B, so that the temporal and physical burden on the operator O as in the conventional case is greatly reduced.

Furthermore, in the present embodiment, the controller 150 (selection module 157) of the commodity data registration apparatus 102 displays the transfer destination selection screen P2 (refer to FIG. 8) on the display device 114 for selecting the checkout apparatus 103 which becomes the transfer destination of the transaction data for one transaction in Act S6; however, the present invention is not limited to that.

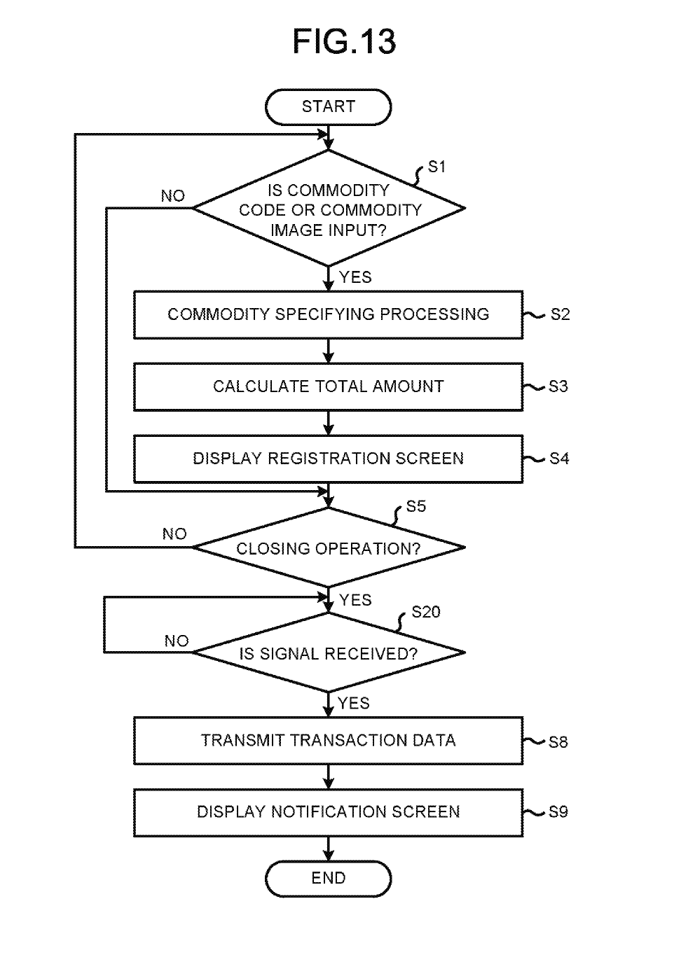

FIG. 13 is a modification of the flowchart illustrating the flow of the commodity sales registration processing executed by the commodity data registration apparatus 102. As shown in FIG. 13, for example, the controller 150 (selection module 157) of the commodity data registration apparatus 102 waits for reception of the signal from the checkout apparatus 103 in which the microswitch SW of the basket placing table 21 is turned on without displaying the transfer destination selection screen P2 (refer to FIG. 8) on the display device 114 (Act S20). The controller 150 (selection module 157) of the commodity data registration apparatus 102 determines the checkout apparatus 103 of which the microswitch SW is turned on as the checkout apparatus 103 which becomes the transfer destination of the transaction data of one transaction and sends the transaction data of one transaction (Act S8) on condition that the signal is received from the checkout apparatus 103 of which the microswitch SW of the basket placing table 21 is turned on (Yes in Act S20).

In accordance with the present modification, the controller of the checkout apparatus 103 may transmit that the microswitch SW of the basket placing table 21 is turned on to the commodity data registration apparatus 102, despite whether the transaction data is received or not. As a result, the transaction data is reliably transmitted to the checkout apparatus 103 where the registered basket B is positioned. In this case, the controller 50 (recognition module 53) of the checkout apparatus 103 determines that the registered basket or the basket moving body 200 with the registered basket placed thereon is positioned at the time of receiving the transaction data.

### Second Embodiment

Next, the second embodiment is described with reference to the accompanying drawings. The same components as those in the first embodiment described above are denoted by the same reference numerals and the description thereof is omitted. The present embodiment differs from the first embodiment in the basket moving body. In the present embodiment, the commodity to which the commodity registration is already executed is inserted into the shopping basket placed on the working table 104 on the left side of the commodity data registration apparatus 102 as seen from the operator O side.

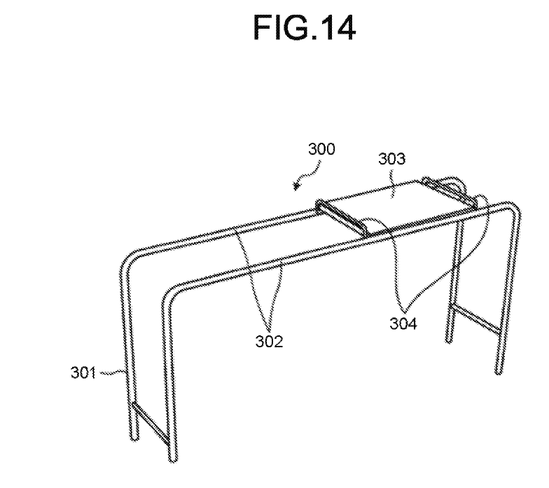

FIG. 14 is a perspective view illustrating the appearance of a basket moving body 300 according to the second embodiment.

As shown in FIG. 14, the basket moving body 300 includes a rectangular frame 301 formed of a round bar shaped metal. The frame 301 is integrated with a rail 302 extending along a movement route of the shopping basket from a placement position of the shopping basket on the working table 104 to the basket placing table 21 of the checkout apparatus 103B. In other words, the rail 302 is a part of the frame 301 constituting the basket moving body 300. The rails 302 are a pair of round bar-shaped metal rods extending linearly, and are provided in parallel along the movement route at equal intervals.

In addition, the basket moving body 300 is provided with a basket receiving table 303 of a flat plate shape provided in a movable manner along the rail 302. Protruding members 304 protruding from the upper surface of the basket receiving table 303 are provided on the upstream side and downstream side of the route in the basket receiving table 303. By providing the protruding members 304 on the basket receiving table 303 in this manner, it is possible to prevent the shopping basket from dropping out of the basket receiving table 304.

The height position of the upper surface of the basket receiving table 303 of the basket moving body 300 is substantially coincident with the height positions of the upper surfaces of the working table 104 and the basket placing table 21.

The operation of the operator O in a case in which the series of the commodity sales registration processing in the commodity data registration apparatus 102 is terminated and the checkout apparatus 103B installed away from the working table 104 is selected is described.

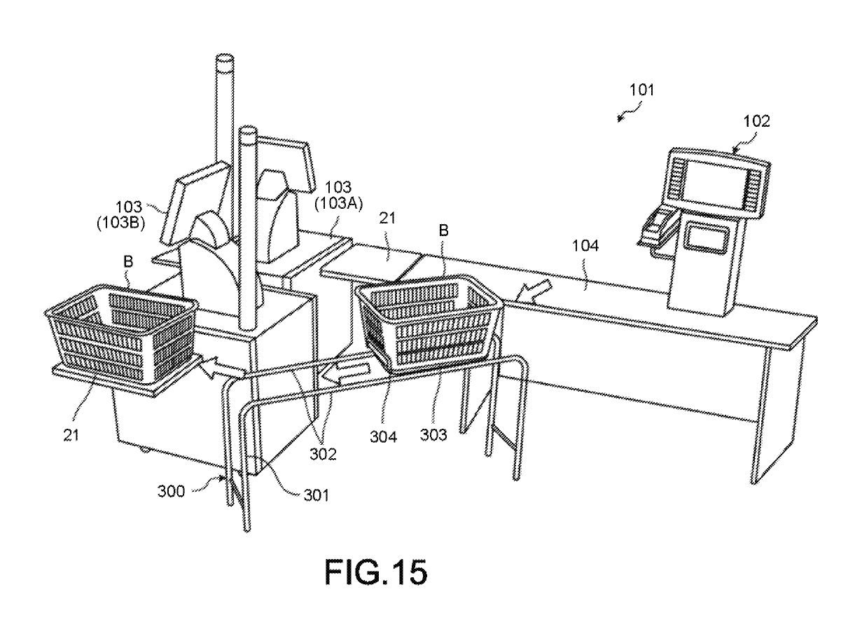

If the checkout apparatus 103B installed away from the working table 104 is selected, the operator O moves the basket receiving table 303 of the basket moving body 300 with the registered basket B placed thereon to the basket placing table 21 of the checkout apparatus 103B installed away from the working table 104. FIG. 15 is a diagram illustrating an example of the movement of the shopping basket by the basket moving body 300. As shown in FIG. 15, if the checkout apparatus 103B installed away from the working table 104 is selected, the operator O places the registered basket B on the basket receiving table 303 of the basket moving body 300. Thereafter, the operator O slides the basket receiving table 303 of the basket moving body 300 with the registered basket B placed thereon to the vicinity of the basket placing table 21 of the checkout apparatus 103B installed away from the working table 104. Then, the operator O moves the registered basket B onto the basket placing table 21 of the desired checkout apparatus 103B and returns the basket receiving table 303 to the original position. In this way, even if the checkout apparatus 103B installed away from the working table 104 is selected, the basket receiving table 303 of the basket moving body 300 with the shopping basket placed thereon can be smoothly slid to the vicinity of the basket placing table 21 of the checkout apparatus 103B, so that the temporal and physical burden on the operator O as the conventional case in which the operator O conveys the registered basket B by hand to move it to the distant checkout apparatus 103B is greatly reduced.

In the present embodiment, as shown in FIG. 15, one basket receiving table 303 is provided in the basket moving body 300 to slidably move the registered basket B; however, the present invention is not limited to that. For example, a plurality of the basket receiving tables 303 may be provided on condition that the length thereof corresponds to the length of the rail 302. In this way, even if there are plural registered baskets B, it becomes possible to slide the plurality of the registered baskets B.

In accordance with the present embodiment, even if the checkout apparatus 103B installed away from the working table 104 is selected, the basket receiving table 303 of the basket moving body 300 with the shopping basket placed thereon can be smoothly slid to the vicinity of the basket placing table 21 of the checkout apparatus 103B, so that the temporal and physical burden on the operator O as the conventional case in which the operator O conveys the registered basket B by hand to move it to the distant checkout apparatus 103B is greatly reduced.

(First Modification)

A movement restriction mechanism for limiting the movement of the basket receiving table 201 of the basket moving body 200 and the basket receiving table 303 of the basket moving body 300 described in each embodiment may be provided.

For example, in the case of the basket moving body 200, the movement restriction mechanism enables the basket receiving table 201 to move in the vertical direction by a lever operation of the operator O. Therefore, in a state where the basket receiving table 201 of the basket moving body 200 is superimposed on the working table 104, the operator O descends the basket receiving table 201 by the lever operation and enables the frame 202 supporting the basket receiving table 201 to contact with the upper surface of the working table 104 to fix the basket moving body 200 on the working table 104. At the time of moving the registered basket B to the checkout apparatus 103B, the operator O operates the movement restriction mechanism by the lever operation to raise the basket receiving table 201 to move the basket moving body 200 with the registered basket B placed thereon to the basket placing table 21 of the checkout apparatus 103B. Furthermore, in a state where the basket receiving table 201 of the basket moving body 200 is superimposed on the basket placing table 21 of the checkout apparatus 103B, the operator O descends the basket receiving table 201 by operating the movement restriction mechanism by the lever operation and enables the frame 202 supporting the basket receiving table 201 to contact with the basket placing table 21 of the checkout apparatus 103B to fix the basket moving body 200 on the working table 104.

In this way, it is possible to avoid a situation where the basket moving body 200 suddenly moves in an unexpected timing or direction for the operator O, and safety can be secured.

For example, in the case of the basket moving body 300, the movement restriction mechanism enables the basket receiving table 303 to be fixed to the rail 302 by the lever operation of the operator O. Therefore, in the state where the registered basket B is not placed, the operator O operates the movement restriction mechanism by the lever operation to fix the basket receiving table 303 to the rail 302. At the time of moving the registered basket B to the checkout apparatus 103B, the operator O operates the movement restriction mechanism by the lever operation to release the fixation of the basket receiving table 303 to the rail 302 to move the basket receiving table 303 with the registered basket B is placed thereon to the vicinity of the basket placing table 21 of the checkout apparatus 103B. Furthermore, if the registered basket B is moved to the basket placing table 21 and the basket receiving table 303 is returned to the original position thereof, the operator O operates the movement restriction mechanism by the lever operation to fix the basket receiving table 303 to the rail 302.

In this way, it is possible to avoid a situation where the basket receiving table 303 suddenly moves in an unexpected timing or direction for the operator O, and safety can be secured.

(Second Modification)

A movement restriction mechanism for limiting the movement of the basket receiving table 201 of the basket moving body 200 and the basket receiving table 303 of the basket moving body 300 described in each embodiment may be provided.

For example, in the case of the basket moving body 200, the movement restriction mechanism is controlled by the controller 150 of the commodity data registration apparatus 102, and is provided with an electromagnetic lock for locking the working table 104 and the basket moving body 200. Then, in the state where the basket receiving table 201 of the basket moving body 200 is superimposed on the working table 104, the movement restriction mechanism keeps the electromagnetic lock in a locked state to fix the basket moving body 200 to the operating table 104. If the transfer destination selected in the transfer destination selection screen P2 (refer to FIG. 8) is the checkout apparatus 103B installed away from the working table 104, the controller 150 of the commodity data registration apparatus 102 performs control to switch the electromagnetic lock to an unlocked state. As a result, the operator O can move the basket moving body 200 with the registered basket B placed thereon to the basket placing table 21 of the checkout apparatus 103B.

As a result, if the checkout apparatus 103 which is the transfer destination is selected at the completion of the series of the commodity sales registration processing, safety and operability can be ensured by controlling the movement of the basket moving body 200 only if the transfer destination is the checkout apparatus 103B installed away from the working table 104.

For example, in the case of the basket moving body 300, a movement restriction mechanism is controlled by the controller 150 of the commodity data registration apparatus 102, and is provided with an electromagnetic lock for locking the rail 302 and the basket receiving table 303 of the basket moving body 300. Then, in a state where the registered basket B is not placed, the movement restriction mechanism fixes the basket receiving table 303 to the rail 302 by keeping the electromagnetic lock in a locked state. If the transfer destination selected in the transfer destination selection screen P2 (refer to FIG. 8) is the checkout apparatus 103B installed away from the working table 104, the controller 150 of the commodity data registration apparatus 102 performs the control to switch the electromagnetic lock to an unlocked state. As a result, the operator O can move the basket receiving table 303 with the registered basket B placed thereon to the basket placing table 21 of the checkout apparatus 103B.

As a result, if the checkout apparatus 103 which is the transfer destination is selected at the completion of the series of the commodity sales registration processing, safety and operability can be ensured by controlling the movement of the basket receiving table 303 of the basket moving body 300 only if the transfer destination is the checkout apparatus 103B installed away from the working table 104.

(Third Modification)

The rail 302 of the basket moving body 300 described in the second embodiment extends along the movement route of the shopping basket from the placement position of the shopping basket on the working table 104 to the checkout apparatus 103B installed away from the working table 104; however, the present invention is not limited to this, and it is also possible to further include a rail along the movement route of the shopping basket up to the checkout apparatus 103A installed linearly in proximity to the working table 104. In such a case, a movement restriction mechanism for restricting the movement of the basket receiving table 303 of the basket moving body 300 may be provided. Specifically, the movement restriction mechanism includes a switching mechanism for switching a plurality of rails that is controlled by the controller 150 of the commodity data registration apparatus 102. The controller 150 of the commodity data registration apparatus 102 controls the switching mechanism according to the transfer destination selected in the transfer destination selection screen P2 (refer to FIG. 8) . As a result, the operator O can reliably move the basket receiving table 303 with the registered basket B placed thereon to the basket placing table 21 of the checkout apparatus 103 selected in the transfer destination selection screen P2 (refer to FIG. 8).

(Fourth Modification)

For example, a bringing-out restriction mechanism for restricting bringing out of the registered basket B until the checkout processing described later at the checkout apparatus 103B by the customer C is terminated is provided in the basket receiving table 201 of the basket moving body 200 described in the first embodiment.

The bringing-out restriction mechanism provided in the basket moving body 200 is controlled by the controller 50 of the checkout apparatus 103B, and is provided with an electromagnetic lock for locking the basket receiving table 201 of the basket moving body 200 and the registered basket B. Then, the controller 50 of the checkout apparatus 103B performs the control to switch the electromagnetic lock to the unlocked state if the checkout processing is terminated. Thus, it is possible to prevent unfair practice that the customer C takes away the shopping basket without performing the checkout with the checkout apparatus 103B.

While certain embodiments of the present invention have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A checkout system, comprising:
a commodity data registration apparatus configured to execute a commodity sales registration processing;
a table on which to temporarily place a registered basket comprising a registered commodity after the commodity sales registration processing;
a first checkout apparatus positioned next to the table and configured to execute a checkout processing based on data relating to the commodity sales registration processing selectively sent from the commodity data registration apparatus;
a second checkout apparatus positioned next to the first checkout apparatus and configured to execute a checkout processing based on data relating to the commodity sales registration processing selectively sent from the commodity data registration apparatus; and
a recognition module configured to recognize that the registered basket is positioned for the first checkout apparatus or the second checkout apparatus which is a transmission destination of the data.

2. The checkout system according to claim 1, further comprising:
a basket moving body configured to set a movement route of the registered basket between the second checkout apparatus and a placement position of the registered basket on the table, wherein
the recognition module recognizes that the registered basket is positioned if the basket moving body is positioned for the first checkout apparatus or the second checkout apparatus which is a transmission destination of the data.

3. The checkout system according to claim 1, wherein
the recognition module notifies an error if the registered basket is not recognized at the first checkout apparatus or the second checkout apparatus selected as the transmission destination of the data.

4. The checkout system according to claim 2, wherein
the recognition module notifies an error if the registered basket is not recognized at the first checkout apparatus or the second checkout apparatus selected as the transmission destination of the data.

5. The checkout system according to claim 2, wherein
the basket moving body comprises a basket receiving table for placing the registered basket, a frame for supporting the basket receiving table, and wheels arranged at lowermost parts of the frame.

6. The checkout system according to claim 5, wherein
the frame of the basket moving body supports the basket receiving table and can superimpose the basket receiving table on an upper surface of the table.

7. The checkout system according to claim 1, wherein
the first checkout apparatus is positioned in a linearly direction relative to a processing direction of the commodity sales registration processing.

8. The checkout system according to claim 1, wherein
the second checkout apparatus is positioned in a direction orthogonal to a processing direction of the commodity sales registration processing.

9. The checkout system according to claim 1, wherein
the second checkout apparatus is positioned at a 90 degree rotation with respect to the first checkout apparatus.

10. The checkout system according to claim 1, wherein
the commodity data registration apparatus comprises a display device, a touch panel, and a keyboard.

11. The checkout system according to claim 1, further comprising:
a customer side display device.

12. The checkout system according to claim 1, wherein
the first and second checkout apparatus each comprises an information processing apparatus, a depositing and dispensing section, a scanner, a display and operation panel, a card reader/writer, and a receipt printer.

13. The checkout system according to claim 3, wherein
the recognition module further comprises a light emitting section for emitting red light indicating the error.

14. The checkout system according to claim 1, further comprising:
a movement restriction mechanism for limiting the movement of the basket moving body.

15. The checkout system according to claim 1, further comprising:
a bringing-out restriction mechanism for restricting bringing out of the registered basket until checkout processing by the customer is terminated.

16. A checkout method, comprising:
executing a commodity sales registration processing;
temporarily placing a registered basket comprising a registered commodity after executing the commodity sales registration processing;
executing a first checkout processing based on data relating to the commodity sales registration processing selectively sent from a commodity data registration apparatus;
executing a second checkout processing based on data relating to the commodity sales registration processing selectively sent from the commodity data registration apparatus; and
recognizing that the registered basket is positioned for a first checkout apparatus corresponding to the first checkout processing or a second checkout apparatus corresponding to the second checkout processing which is a transmission destination of the data.

17. The checkout method according to claim 16, further comprising:
setting a movement route of the registered basket between the second checkout apparatus and a placement position of the registered basket on a table; and
recognizing that the registered basket is positioned if a basket moving body is positioned for the first checkout apparatus or the second checkout apparatus which is a transmission destination of the data.

18. The checkout system according to claim 16, further comprising:
notifying an error if the registered basket is not recognized at the first checkout apparatus or the second checkout apparatus selected as the transmission destination of the data.

19. The checkout method according to claim 18, wherein
notifying comprises emitting a red light.

20. The checkout method according to claim 16, further comprising:
limiting the movement route of the registered basket movement.
